(19) United States
(12) Patent Application Publication
(10) Pub. No.: US 2008/0014903 A1
(43) Pub. Date: Jan. 17, 2008

(54) Method For Charging For A Service In A Telecommunications/Data Network

(76) Inventors: Frank Burghardt, Berlin (DE); Georg Kastelewicz, Berlin (DE); Peter Kim, Berlin (DE); Martin Kissner, Kremmen (DE)

Correspondence Address: BELL, BOYD & LLOYD, LLP, P.O. BOX 1135, CHICAGO, IL, 60690, US

(21) Appl. No.: 11/774,404

(22) Filed: Jul. 6, 2007

Related U.S. Application Data
(63) Continuation of application No. 10/933,498, filed on Sep. 3, 2004.

(30) Foreign Application Priority Data
Sep. 5, 2003 (DE) 10341903.9

(51) Int. Cl. H04M 11/00

(52) U.S. Cl. 455/406

(57) ABSTRACT

A method for charging for a service in a telecommunications/data network, in particular UMTS mobile radio network, transactions which relate to debits being transmitted to a debiting system on network elements which implement a debiting interface, by means of an adapted transmission protocol, a hot-billing protocol which supports a termination message of the debiting system being used as the transmission protocol, a network element which is involved in the debiting transaction transmitting a message to the debiting system both at the start and at the end of the service and the service being timed in the debiting system in parallel with the execution of the service and debiting being carried out in response to the measurement result.

### CLAIM FOR PRIORITY

This application claims the priority to German Application No. 10341903.9, filed Sep. 5, 2003, the contents of which are hereby incorporated by reference.

### TECHNICAL FIELD OF THE INVENTION

The invention relates to a method for charging for a service in a telecommunications/data network.

### BACKGROUND OF THE INVENTION

The charging for telecommunications services and data services on the basis of a credit which is paid for in advance (prepaid basis) has become an established charging mechanism and is highly significant economically in view of the increasing amount of information, products and services which are provided over third-generation mobile radio networks. Particular emphasis is placed here on ensuring a high degree of accuracy and clarity of the charging process both for services which are billed in a time-based fashion and services which are billed in a volume-based fashion. The greatly increasing number of parties involved in such systems—providers (merchants), customers (consumers), payment service providers, wireless application service providers, advertisers, portal providers etc.—makes it necessary to use standardized interfaces and protocols with the highest degree of flexibility with respect to their specific requirements and system preconditions.

It is a basic fact that in order to charge for services which require credit monitoring, transactions which relate to charging are transmitted by means of a suitable protocol to a charging system on network elements of the telecommunications/data network. The protocols which are known for this purpose can be divided into three groups with the following features:
Offline charging or ticketing: the messages are collected at the network element and measured and charged in the debiting system at a later time by means of the time stamps which they contain.
Online charging: after the network element has transmitted a start message, it waits for a response from the debiting system before it carries out the service.
Hot billing: the network element transmits a message at the start and at the end of the service; the message is timed and charged in the debiting system in parallel with the implementation of the service. For services which are measured in a volume-oriented fashion, a snapshot of the volume counter is transmitted in each message.

For prepaid systems, it is currently necessary to use an online charging protocol. In this context, it is necessary for the actual network element which is involved in a charging transaction to know the state of the service which is to be measured with respect to its time dimension. In addition, in these systems the interfaces (charging interfaces) bear a relatively high processing burden.

### SUMMARY OF THE INVENTION

The invention discloses a simplified configuration of the system and a reduction in the processing load on the network elements.

In one embodiment of the invention, contrary to the previously accepted ideas, a hot billing protocol can also be used for a charging system with credit monitoring, in particular a prepaid system, provided that specific conditions are fulfilled. In this way, charging on a prepaid basis (prepaid charging) can be carried out with the customary properties, specifically
the service can be interrupted with accuracy to the second as the prepaid credit is used up, and
the possibility of determining the end of the service a priori so that cyclical debiting processes are not necessary.

One advantage of the method/system proposed is that its simplicity permits application on more network elements. In particular it is no longer necessary for the network element itself to know the state of a service which is to be timed but rather it is known at the start or end. As a result, the method which is presented is suitable for distributed systems (in which a pool of network elements makes a service available). In addition, there is less resulting loading on the charging interface. This method is therefore suitable in particular for IP-based, session-oriented services (for example video call, voice call, streaming) which require infrastructure which is optimized in terms of cost.

In one preferred embodiment of the invention, the IETF diameter protocol is used as the transmission protocol. Furthermore, the standard diameter protocol, with additional use of the termination message provided therein, can be used as the transmission protocol in conjunction with the RF interface which is defined by 3GPP.

For credit control it is necessary to require that the hot billing protocol support the termination message (ABORT) in the charging system. This termination message is a termination message which is independent of the other protocol messages. The termination message can therefore be transmitted at any desired times by the debiting system to a network element which is involved in the debiting transaction. Such a termination message can also be referred to as an “unsolicited termination message”, “independent termination message”, “independent abort message” or “out-of-regular-flow message”. The unsolicited termination message is transmitted by the server (debiting system, billing system) to the network element. The unsolicited termination message terminates the provision of the service; as a result the exchange of messages which takes place after this between the debiting system or billing system and the network element changes. The method according to the invention can therefore be configured in such a way that a hot billing protocol which supports an unsolicited termination message of the debiting system is used as the transmission protocol. An additional requirement for charging a service which is billed in a volume-based fashion is that an interim message can be requested after a maximum permissible transferred volume. It is irrelevant here whether the maximum permissible volume is agreed dynamically by means of the response to the start/interim requests or is agreed in a static fashion.

A precondition for a possible implementation is that in the debiting system there is a wake-up service which can activate the service logic with accuracy to the second using a previously entered time and date.

Since a possible delay depends on the number of wake-up calls in a time unit, it is necessary to arrange in advance that wake-up orders which are already present for this time period will be taken into account when the wake-up call is entered. If a maximum number of wake-up calls per time unit is exceeded, the wake-up order is entered for an earlier time and date.

There is also a precondition that a second charging logic can see the context of the first charging logic.

The first logic may be in a resting state or may be active simultaneously.

It is advantageous if the wake-up time of a first service can be recalculated and changed by means of a second service. This precondition is not obligatory, and as an alternative strategy is handled. For this purpose, an auxiliary service is configured which can be activated by a wake-up order and can recalculate the service running time. The “used-up” credit can be debited in the process. The auxiliary service is required only if the wake-up time of a service cannot be changed by another service.

It is also advantageous that a first service can be “woken up” by a second service in order to bill for credit which has been used up to that point. This precondition is also not obligatory since under the aforesaid preconditions the second service can itself calculate and take into account the amount to be billed without the amount actually being debited at this time. In the explanation of the calculations it is assumed that this precondition is fulfilled.

A general precondition is that a service is enabled (started) by the network element as early as possible after double the time which is necessary for the transmission of a message from the network element to the charging system. This precondition is necessary in order to terminate a service before the start if the necessary credit is not available at the start of the transmission. The precondition does not apply if the system waits for a reply to the request.

### BRIEF DESCRIPTION OF THE DRAWINGS

The invention is described below with reference exemplary embodiments illustrated in the drawings, in which:

FIG. 1 is a schematic view of the system linkage between the telecommunications/data network and the charging system when charging is being processed.

FIG. 2 shows the possible charging sequence using the IETF diameter protocol.

FIG. 3 shows a schematic view of the charging process carried out by a pool of http servers as an exemplary embodiment of the invention.

### DETAILED DESCRIPTION OF THE INVENTION

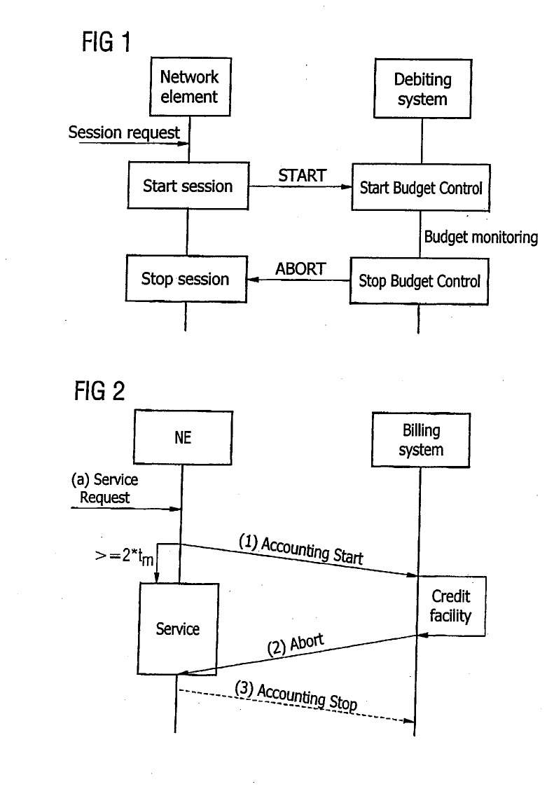

FIG. 1 shows how a network element which is involved in a service which is charged for transmits a signal START to the assigned debiting system after the request for the implementation of a service (session request) at the start of the implementation of the service (start session), and budget monitoring is started at the debiting system (start budget control). At the end of the budget monitoring—for example when the prepaid credit is used up—(stop budget control), the debiting system transmits a signal ABORT to the network element, causing the implementation of the service to be terminated there (stop session).

FIG. 2 shows a possible charging sequence by means of IETF diameters, specifically a time-based service, which can however be carried out in a similar way in a volume-oriented fashion. The systems involved are again a network element NE and a suitable billing system. If a service is requested from the NE (a service request), the NE firstly transmits an accounting start request (1) to the billing system. The latter defines a maximum possible end time of the service (“credit facility”) on the basis of the current credit facility.

The network element NE makes the service available at the earliest after a delay which corresponds at least to twice the running time of the accounting start request (2*tₘ; which can be configured in practice) After the service made available has been terminated in the usual way, the NE would transmit an accounting stop request (3).

However, since, in the example shown in FIG. 2, the credit facility is reached earlier, the billing system transmits an abort request (2) at the previously defined time, and the said abort request (2) causes the service to be terminated immediately in the NE.

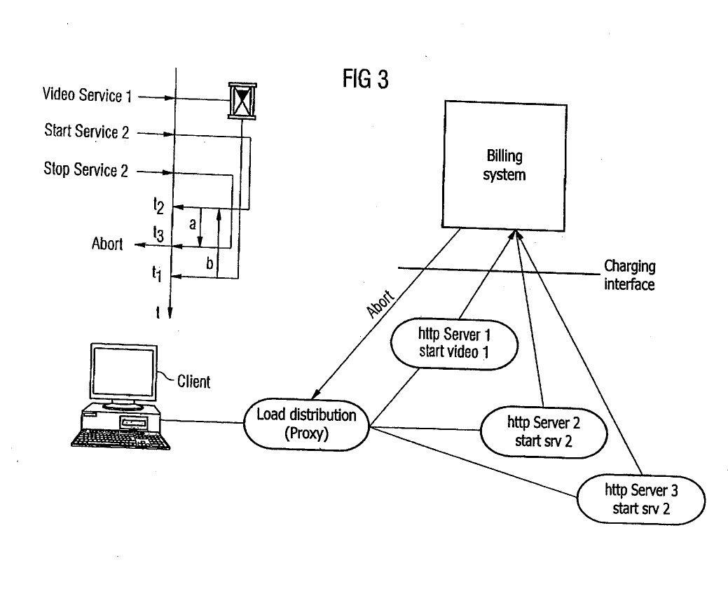

FIG. 3 is a schematic view of a group of three http servers interacting with a proxy, which carries out the load distribution, during the interleaved implementation of two services for one client, which services are charged by means of a billing system which is linked to the computer network via a charging interface. The charging process follows the principles explained above.

In the multi-server configuration which is shown, a credit facility can be used by a plurality of services independently of one another. It is a precondition that the communications flow from the client firstly runs via a load distributor which includes the servers 1 . . . 3 providing the service in the sequence. The service “video service 1” is made available exclusively by the http server 2, while the “service 2” is made available by servers 2 and 3 in accordance with a load distribution configuration.

It will then be assumed that the client starts the video service 1 first. The billing system then calculates the maximum possible period of use with end time t₁ on the basis of the existing credit facility. At a somewhat later time, the user starts the service 2, which is communicated to the billing system (randomly) by the server 2. The possible period of use is then reduced by the amount b (upward arrow in the diagram). The new, calculated end time is then t₂.

If the service 2 is terminated again, a cost factor drops away and the remaining credit facility is then sufficient again for a time period which is longer by the amount a. This is illustrated by a downward arrow in the diagram. The end point is then t₃.

At the time t₃, an abort is then transmitted. The diagram illustrates the transmission of the abort request to the load distributor in order to be able to terminate a service which is provided in a distributed fashion (such as service 2).

Using the method according to the invention it is possible to charge for both time-based services and volume-based services in a simple and precise way, specifically also for the case in which a second service is added while a first service of whichever type is being carried out. These important application cases are explained in more detail below.

Sequence when Charging for a Time-Based Service

The charging server receives a start request when a service is started on the network element. The tariff s (money/time unit) is determined by means of rating. The credit c of the user is known.

The possible use time is therefore obtained from
t=c/s
The service therefore makes a wake-up order with now ( )+t.

If a stop request is received before t, the charge is correspondingly calculated and debited.

Otherwise the charging logic is activated by the wake-up order and a termination has to be transmitted.

The termination is accurate to the second because the running time of the charging logic and its possible deviations are known beforehand and can be taken into account when entering the wake-up time. The termination can be processed with priority.

It is necessary to recalculate in the meantime only if external requests are received which can bring about a change in parameters and therefore necessitate a re-rating and re-determination of the running time.

Sequence when Charging for an Additional Time-Based Service

If a second time-based service is added to a running time-based service, the possible running time must be recalculated since the credit has to be distributed between both services.

The service is in turn signaled by means of a start request. The tariffs s1 and s2 are known. The remaining credit c of the user at this time is known (for this purpose the credit which has already been used up is simply billed by the first service).

In order to determine the data, at least a reading access to the context of the first service is necessary (alternative strategy if writing access impossible, see below).

The running times are obtained as follows:
t1=c1/s1
t2=c2/s2
c=c1+c2

The maximum possible running time during which the two services are used simultaneously will now be determined.
t1=t2
c1/s1=c2/s2

By using c=c1+c2, the following is obtained
c1=c*s1/(s1+s2)

All the data on the right-hand side are known. The values c2 and t1 can be determined from the result by means of the formulas which are given above.

The new wake-up time now ( )+t1 is now entered for the two services. Both services must be terminated at the given time. Interim activation is not necessary.

If it is not possible to change the wake-up time of a first service from a second charging logic, a suitable credit must be reserved. For this reason, the entire credit of the user is not used but instead only some of it (for example 20%, with a certain minimum). When this time expires, a recalculation of the end time is carried out by the service itself by means of the aforementioned auxiliary service. This method requires periodic activation of the services. This replacement solution can block the use of a second service even if sufficient credit is available on the account.

Sequence when Charging for an Additional Volume-Based Service

A volume-based service can be measured only by the network element. For this purpose, the granted-unit method is used in which a volume is made available periodically to the network element. Each “tranche” has a volume which is fixed by the charging system and a maximum chronological extent. When a start request is received, an adequate volume and a corresponding amount of money is therefore reserved. This affects the running time of a time-based service which is already running.

The determination of the reserve amount for the volume-based service requires, inter alia, knowledge of the maximum throughput rate per time unit dmax. The reserved volume is assumed to be
v=dmax*t2
where once more, it is to be the case that
t1=t2.

For the sake of simplification it is once more a precondition that credit which has already been used up has been billed at this time. The credit is then distributed between the (first) time-based service and the (second) volume-based service:
t=c1/s1
c2<dmax*t2*s2
the tariff s2 being in units of money per volume unit. In addition, c=c1+c2.

By insertion the following is obtained
c2<dmax*((c−c2)/s1)*s2

The unitless coefficient dmax*s2/s1 is to be referred to as k.
c2<k*(c−c2)

Since the values are positive, by reconfiguring the following is obtained
c2<c*k/(k+1)

That is to say the credit which is to be reserved is limited by the right-hand side. It can be calculated from known values. The other values t1, t2, c1 are obtained by inserting the value c2 into the equations above.

This formula applies to a “last tranche”, i.e. the volume c2 which is to be reserved may be smaller due to other conditions (for example maximum volume to be reserved for a tranche or maximum chronological extent of a tranche). The values and running times must be redetermined for each interim message.

For the respective next tranche, the maximum remaining running time of the two services can therefore be calculated from the given formula. The first service can be terminated with an accuracy to the second by means of a corresponding wake-up order.

This method in itself has the disadvantage that a remaining amount from the volume-based service is not taken into account. However, for services which are billed in a volume-based fashion it is typical for the service to “be resting” over a relatively long time and for no charge to be incurred. The remaining amount becomes large if a large tranche c2 is selected but no volume at all is produced by the service.

For this reason it is proposed to select a tranche size for the volume-based service which depends on the available remaining credit and the anticipated volume to be produced (for example on the basis of the previous user behavior), i.e. c2 is not limited just by the formula given above but also by taking into account a specific minimum also by a factor f where f<100%:
c2<c*k/(k+1)*f

The recalculation of the running times for existing services is carried out at each interim message of the service which is billed in a volume-based fashion.

The implementation of the invention is not restricted to these application cases and the system configurations which are mentioned above but rather it is also possible with a large number of modifications which lie within the scope of the activity of a person skilled in the art.

What is claimed is:

1. A method for charging for a service in a telecommunications/data network, comprising:
transmitting transactions which relate to debits on network elements which implement a debiting interface to a debiting system by means of an adapted transmission protocol, wherein a hot billing protocol which supports a termination message of the debiting system is used as the transmission protocol; and
transmitting, via a network element which is involved in the debiting transaction, a message to the debiting system at the start and end of the service and the service being timed in the debiting system in parallel with execution of the service and debiting being carried out in response to the measurement result, wherein a use time of a service which is charged in a time-based fashion is determined at the start of use based on the value of a prepaid credit.

2. The method as claimed in claim 1, wherein an IETF diameter protocol is used as the transmission protocol.

3. The method as claimed in claim 1, wherein the standard diameter protocol, with additional use of the termination message provided therein, is used as the transmission protocol in conjunction with the RF interface which is defined by 3GPP.

4. The method as claimed in claim 1, wherein the service is an IP-based, session-oriented service, and comprises one of a voice call, video call or streaming service.

5. The method as claimed in claim 1, wherein the service is a service which is charged in a volume-based fashion and the transmission protocol makes it possible to request an interim message after a predetermined data volume has been transmitted.

6. The method as claimed in claim 1, wherein a first and second charging logic are implemented in the debiting system, the second charging logic being able to view the context of the first debiting logic.

7. The method as claimed in claim 1, wherein a wake-up service for activating a service logic in a precisely timed fashion is implemented in the debiting system.

8. The method as claimed in claim 7, wherein the wake-up service for recalculating and changing the wake-up time of the wake-up service is implemented in the debiting system.

9. The method as claimed in claim 1, wherein the transmission is distributed over the telecommunications/data network.
